(19) United States
(12) Patent Application Publication
(10) Pub. No.: US 2016/0085943 A1
(43) Pub. Date: Mar. 24, 2016

(54) System and Method for Monitoring Clinical Trial Progress

(71) Applicant: Medidata Solutions, Inc., New York, NY (US)

(72) Inventors: Glen de Vries, New York, NY (US); Mladen Laudanovic, New York, NY (US); Angel Janevski, New York, NY (US)

(21) Appl. No.: 14/492,597

(22) Filed: Sep. 22, 2014

(51) Int. Cl. G06F 19/00

(52) U.S. Cl. CPC G06F 19/363

(57) ABSTRACT

A method for monitoring clinical trial progress includes calculating progress curves for clinical trial states. Calculating a progress curve includes assigning values to events for a datapoint in the clinical trial, generating or building pairs of values for each consecutive sequence of the events, summing up the values of pairs of events corresponding to a state change, and determining a state for the datapoint based on the sum of the values. Monitoring clinical trial progress then includes calculating a second progress curve for another clinical trial state and comparing the delay between points of the progress curves. A system for monitoring clinical trial progress is also described.

### BACKGROUND

Clinical trials (also called “clinical studies”) are generally very expensive to undertake and they often take a long time to complete. During the course of a clinical trial, many steps may be taken to ensure optimal execution of the trial and maintain high quality of the data collected. These steps may be applied to various aspects of the trial data, trial participants, and trial execution at the level of trial sites, which constitute the main operating units in a clinical trial. One element of site (and study) monitoring is to monitor the progress of a trial, which, up until now, has not been adequately performed.

### BRIEF DESCRIPTION OF THE DRAWINGS

FIG. 1 is a schematic diagram showing the states in the lifetime of a datapage of a clinical trial, according to an embodiment of the present invention;

FIGS. 2A and 2B are graphs showing verified progress curves for two sites, according to embodiments of the present invention;

FIG. 3A is a block diagram for tracking progress of a clinical trial, according to an embodiment of the present invention;

FIG. 3B is a block diagram of part of the system of FIG. 3A for calculating a progress curve, according to an embodiment of the present invention;

FIG. 4 is a flowchart of a method for determining the state of a datapage, according to an embodiment of the present invention;

FIG. 5 is a flowchart of a method for calculating progress curves, according to an embodiment of the present invention;

FIG. 6 is a graph showing examples of the First State, Last State, and True progress curves for the verified state, according to an embodiment of the present invention;

FIGS. 7A and 7B are graphs showing examples of study progress curves, according to embodiments of the present invention, for two different clinical trials;

FIG. 8 is a graph showing examples of how progress curves can be compared over time, according to an embodiment of the present invention;

FIGS. 9A-9D are graphs showing several examples of the result of periodic sampling methods, according to embodiments of the present invention; and

FIGS. 10A-10B are flowcharts showing how the system as a whole operates, according to embodiments of the invention.

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. In other instances, well-known methods, procedures, components, and circuits have not been described in detail so as not to obscure the present invention.

Embodiments of the present invention may be used to monitor the progress of clinical trials, but the invention is not limited to such embodiments. In monitoring the progress of a clinical trial, one may examine a variety of data elements—a data point, a data record, or a data page. In a clinical trial that records information using, for example, case report forms (“CRFs”), whether manual or electronic (“eCRF”), a data point (or “datapoint”) may be a field on such a form, a data record may be a number of fields on the form, and a data page (or “datapage”) may be the form itself. A datapage may also imply a composite data element in which history and statuses of individual (“lower”) data elements may be combined into a bigger picture. Any of these types of data elements may be monitored; for ease of understanding, this specification will use “datapage” to mean any or all of these data elements, unless a more specific term is called for.

Site and study monitoring have typically been performed with significant time lags and with a fairly coarse view of the data collection and management. Traditional data monitoring tools may utilize only the current status of data elements (sometimes called “object status”) and may not include input from historical changes in the data collection process. That approach may provide information about the present status of a study, but may not allow adequate insight into the events that preceded the current state. In contrast, aspects of the present invention allow the monitoring of a clinical trial by viewing the current and prior statuses of various data elements.

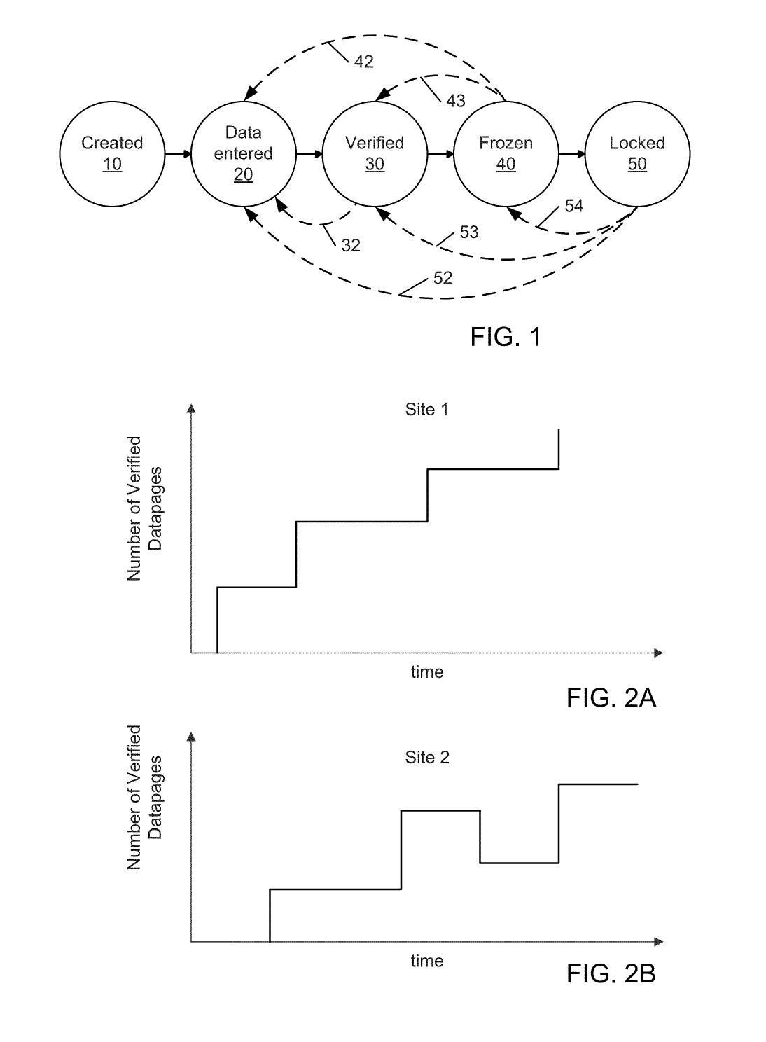

One way of viewing the progress of a clinical trial is in terms of states in the lifetime of a datapage, as shown in the schematic diagram of FIG. 1. Examples of these states are “created” 10, “data entered” 20, “verified” 30, “frozen” 40, and “locked” 50. For example, a datapage may be created by a study designer or other person involved at either a study level or a site level. Then data may be entered on the datapage during a site visit, for example, by a nurse or a principal investigator. The data on the datapage may be verified, for example, by a principal investigator (checking the nurse's input) or a clinical research associate (CRA), whose job it is to monitor entry of data in a clinical trial. Verification may include 100% SDV (source data verification or source document verification) and targeted SDV, both on-site and remote.

The data on the datapage may then be frozen, such as when a patient visit is concluded or when a datapage is completed. After freezing the data, the datapage or a group of datapages may be locked by a study coordinator or other high-level study participant with such rights. Locking typically occurs after data have been reviewed, queries have been resolved, and issues have been addressed, and the database may be ready to undergo statistical analysis for submission to a regulatory agency.

The labels used in FIG. 1 may vary among studies, data vendors, and sponsors. There may be more or fewer than the five shown in the figure. The key to the states in FIG. 1 is that different personnel who have different roles in a study may have different permissions regarding the data. Generally, personnel performing tasks toward the right of the figure have greater data permissions or privileges, and those performing tasks toward to the left may have greater interaction with patients, but such scenarios are not universal. What is also important is that the order of the states shows how the data may be tagged or transformed, and how a study may be monitored during its lifetime. There may be different properties that can be given to or taken from the data elements at different points in time and these properties and changes of properties may be recorded. The state diagram in FIG. 1 and the transitions between the states are just one way to visualize study progression.

The typical progression in the life of a datapage is to go forward (i.e., to the right in FIG. 1) from state to state. However, FIG. 1 also shows dashed arrows indicating possible state transitions that go backward, denoting reversal of the datapage state (e.g., from verified to unverified, locked to unlocked, etc.). For datapages that have already been verified, it may be possible to go backward 32 to the data entry state and re-enter some or all of the information on the datapage. This may be done to correct data that was mis-entered (as discovered in source data verification, for example).

For datapages that have already been frozen, it may be possible to go backward 43 to the verified state or 42 to the data entry state, possibly if some error is discovered in the taking of or recording of data. Such “unfreezing” may be performed by personnel with the correct privileges, e.g., a principal investigator may not unfreeze a datapage, but a study coordinator may do so. Similarly, for datapages that have already been locked, it may be possible to go backward 54 to the frozen state, 53 to the verified state, or 52 to the data entry state. Such “unlocking” may be performed by personnel with even higher privileges than those who may unfreeze the data, such as a study designer or a study coordinator.

All of the transitions from one state to another, both forward and backward, may be captured in an “audit trail,” which is a trail of state changes.

The state of a datapage may be derived from the states of some or all of the datapoints contained on the page. For example a datapage may be verified at time point t when all datapoints in the datapage that require verification are verified (at time t). (A similar derivation may be made for frozen and locked datapages.) This process is called “status rollup.” Thus, equivalent states for datapages may be defined even though they may or may not follow the same transition patterns as datapoints (e.g., a datapage could be signed before it is verified). Therefore, the verified (or frozen or locked) state of one datapage can change between being verified (or frozen or locked) and unverified (or unfrozen or unlocked) if the status of its datapoints is being changed.

Based on these states, progress curves may be calculated and plotted. For every given state and every given site (or entire trial), a progress curve at any moment t during the trial may be defined as the number of datapages in that state at moment t. For example, FIGS. 2A and 2B show progress curves for two sites, showing the number of verified datapages at each site over time. Note that the curves are not always monotonically increasing—in site 2, for example, the number of verified datapages drops at one point.

There are several ways to calculate the progress curves. One way is to calculate and store in real-time all datapage status rollups and changes at any datapoint state change. Another way is to compute datapage states periodically at regular time intervals (e.g. daily) and then calculate and store the resulting progress curves. A third way is to generate progress curves over time by reconstructing datapage statistics historically from a historical trail of datapoint state changes (e.g., audit trails). This last method has the benefit of being computationally feasible, since it does not require continuous/real-time capture of datapage states and does not limit the time resolution at which state changes may be captured.

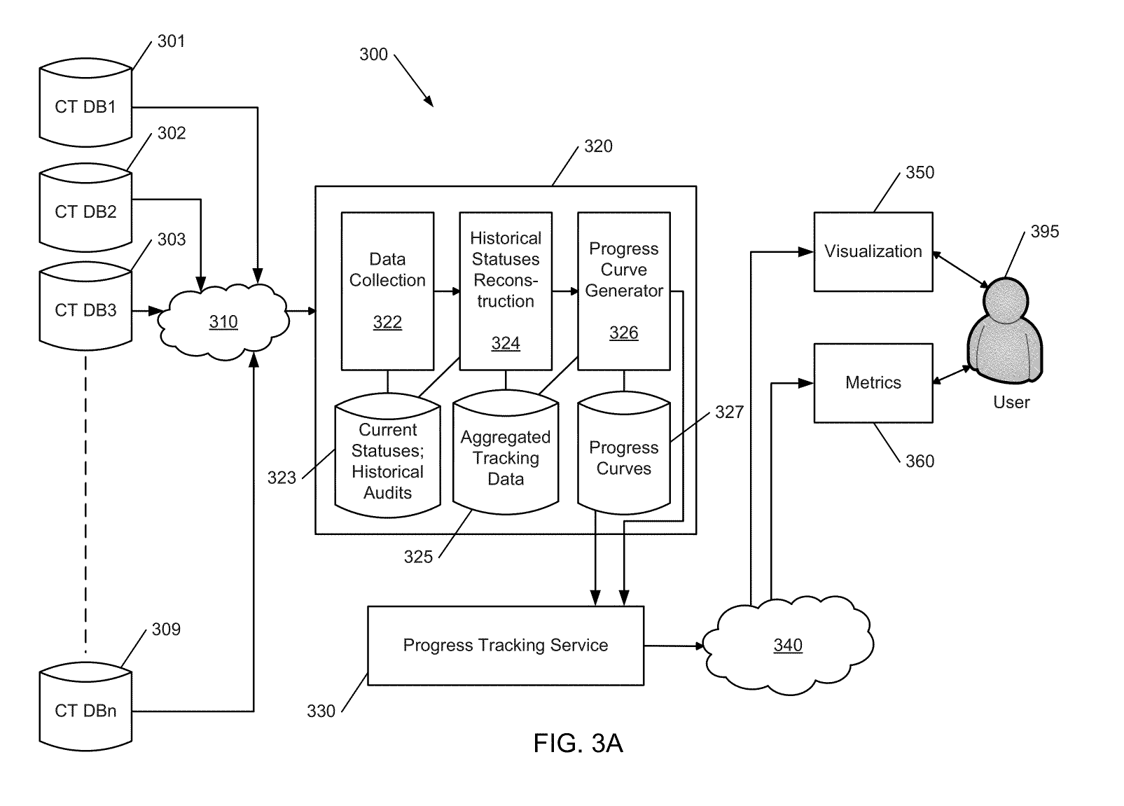

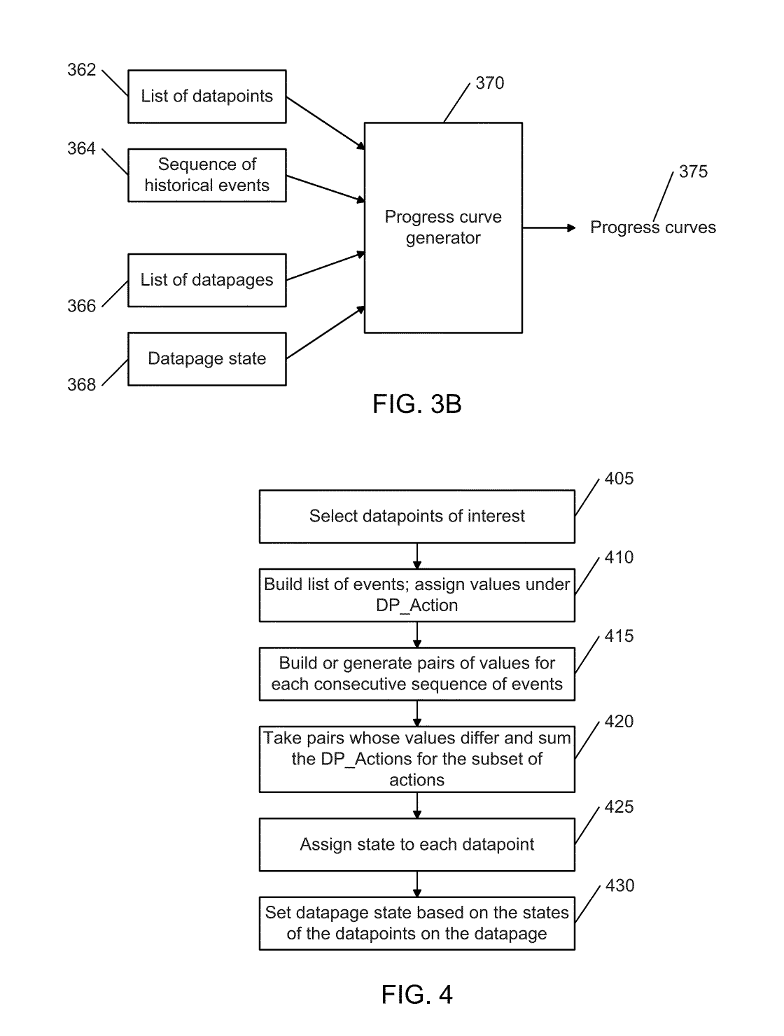

FIG. 3A is a block diagram of system 300 for tracking progress of a clinical trial and using it to provide progress curves and metrics, according to an embodiment of the present invention. Main system block 320 takes as inputs clinical trial databases 301-309 and outputs progress curves that may then be tracked and provided to a user 395 for further actions. Clinical trial databases DB1 to DBn (301-309) may include any type of information used in or derived from a clinical trial, such as patient demographic information, patient medical information, other medical information, drug information, site information, information about principal investigators and other trial management personnel, adverse event information, etc. Non-limiting examples of such a database is provided by Medidata Rave®, an electronic data capture (EDC) and clinical data management (CDMS) platform, Medidata Balance®, a randomization and trial supply management program, clinical trial management systems (CTMS), electronic patient reported outcomes (ePRO) databases, and databases that may store real-time data from devices attached to clinical trial subjects.

Information and data may be transmitted from the clinical trial databases to block 320 via a network 310, which may be the Internet, an intranet, or another public or private network. Access to network 310 may be wireless or wired, or a combination, and may be short-range or longer range, via satellite, telephone network, cellular network, Wi-Fi, over other public or private networks, via Ethernet, or over local, wide, or metropolitan area networks (i.e., LANs, WANs, or MANs).

Block 320 may be a computer, having a processor and memory, or a series of computers, processors, and memory that may themselves be connected via a local or wide-area network. Block 320 may include data collection module 322, historical statuses reconstruction module 324, and progress curve generator 326, along with associated databases—statuses/audits database 323, tracking data database 325, and progress curve database 327. Data collection module 322 collects data from one or more of the CT databases 301-309. This may include digestion, cleaning, and aggregation of some or all of the data in the databases. This module may extract, determine, or calculate current statuses and historical audits of clinical trials, and store that information in current statuses, historical audits database 323. Historical statuses reconstruction module 324 may then use the current statuses and historical audits to reconstruct the history of the clinical trial at issue and generate aggregated tracking data, which are stored in aggregated tracking data database 325. Progress curve generator 326 may then use the aggregated tracking data to generate progress curves, which may be stored in progress curve database 327.

Once the progress curves are generated, block 320 may transmit the progress curves to progress tracking service 330, which may also comprise a computer, processor, and memory. Progress tracking service 330 may comprise a web server that transmits and receives requests to and from visualization and metrics applications/computers 350, 360. Such transmitting and receiving may be done via network 340, which operates in the same manner and with the same variations as network 310.

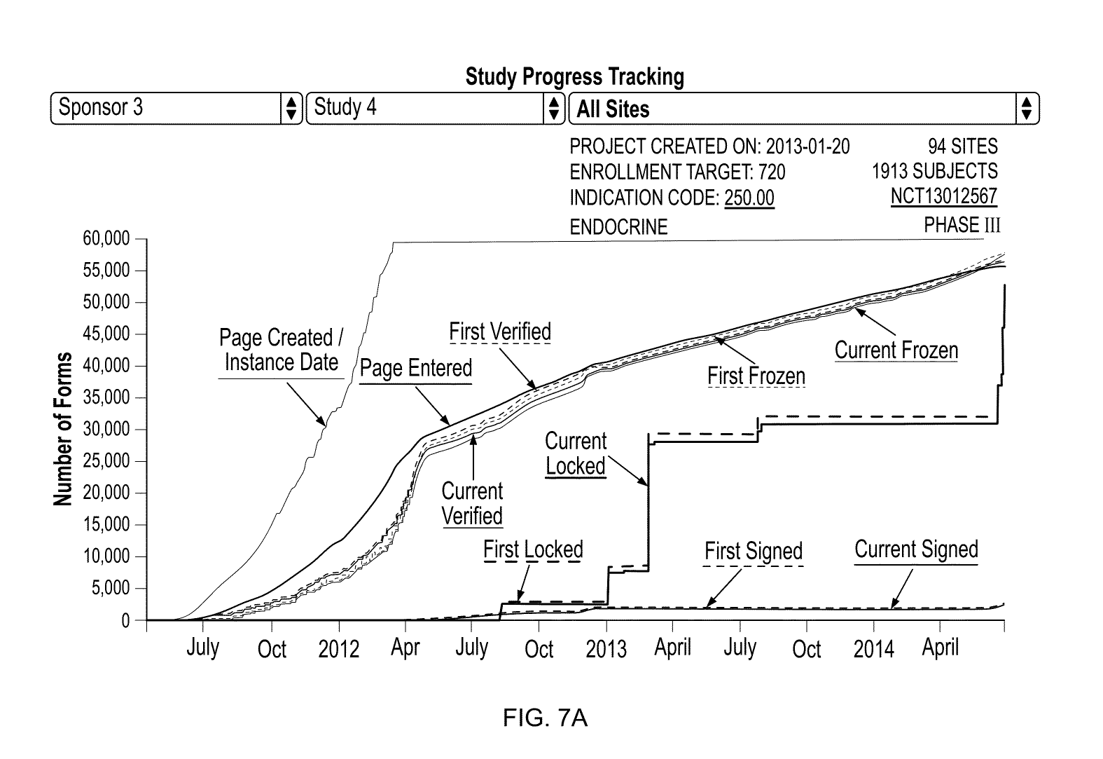

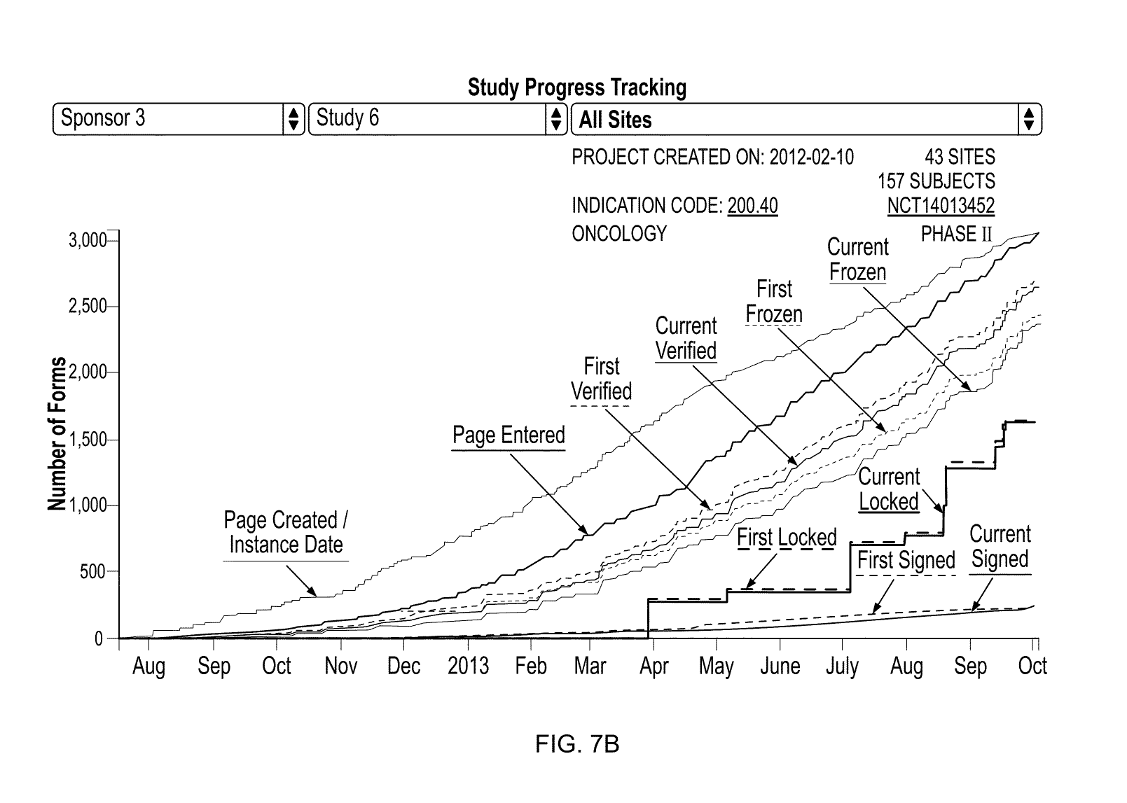

Visualization module 350 may present progress curves on a user's computer, allowing a user to see the curves and manipulate how the data may appear. Users may be able to view the curves on their laptop or desktop computers or on their smartphones or tablets. Some examples of visualization are shown in FIGS. 6 and 7.

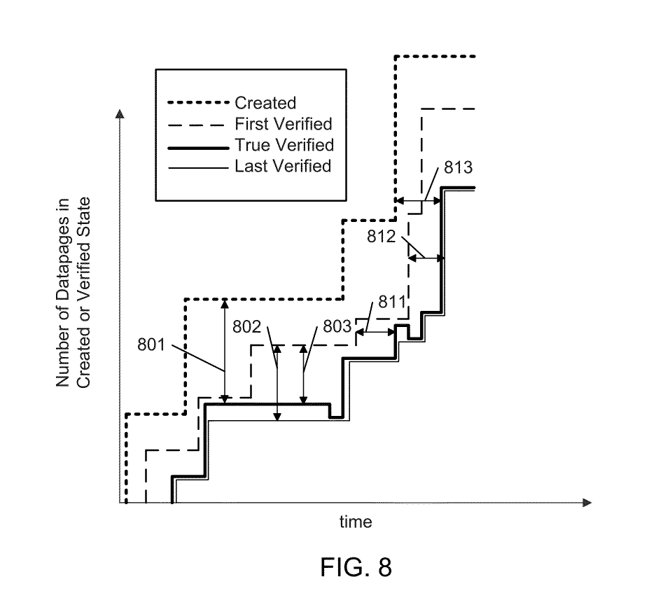

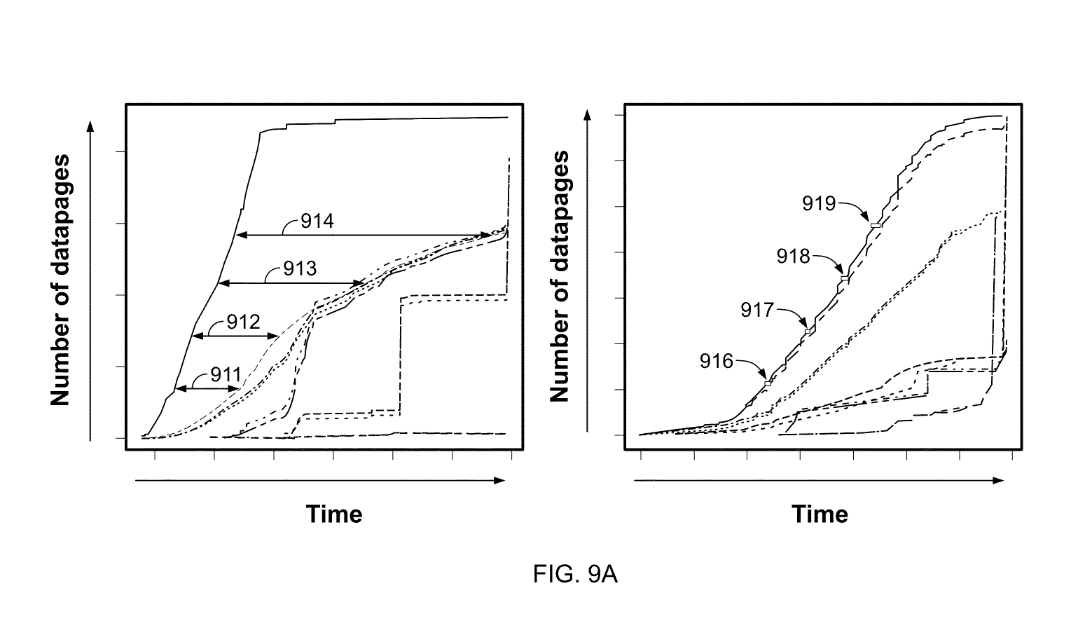

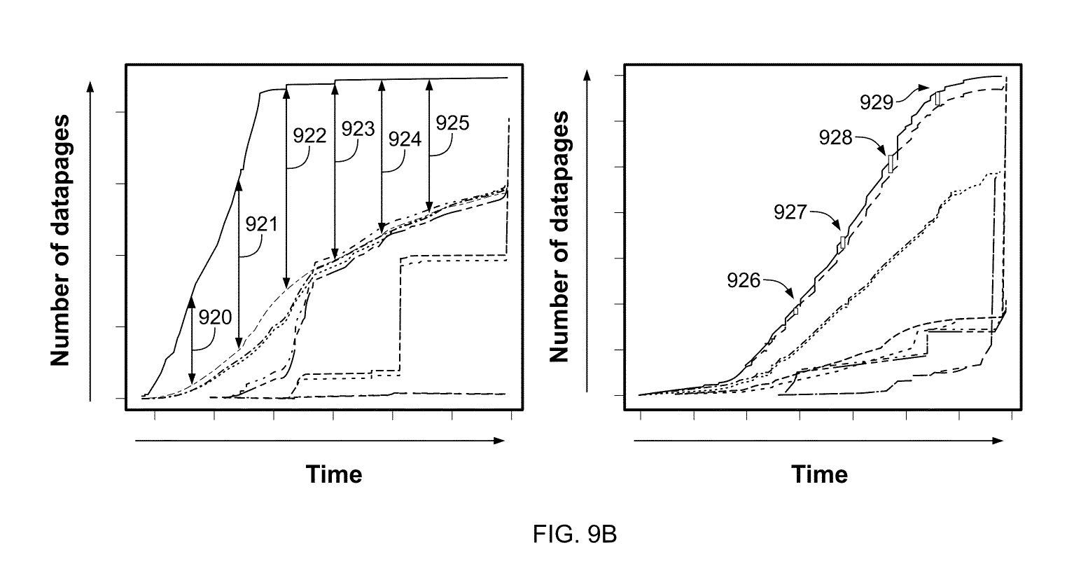

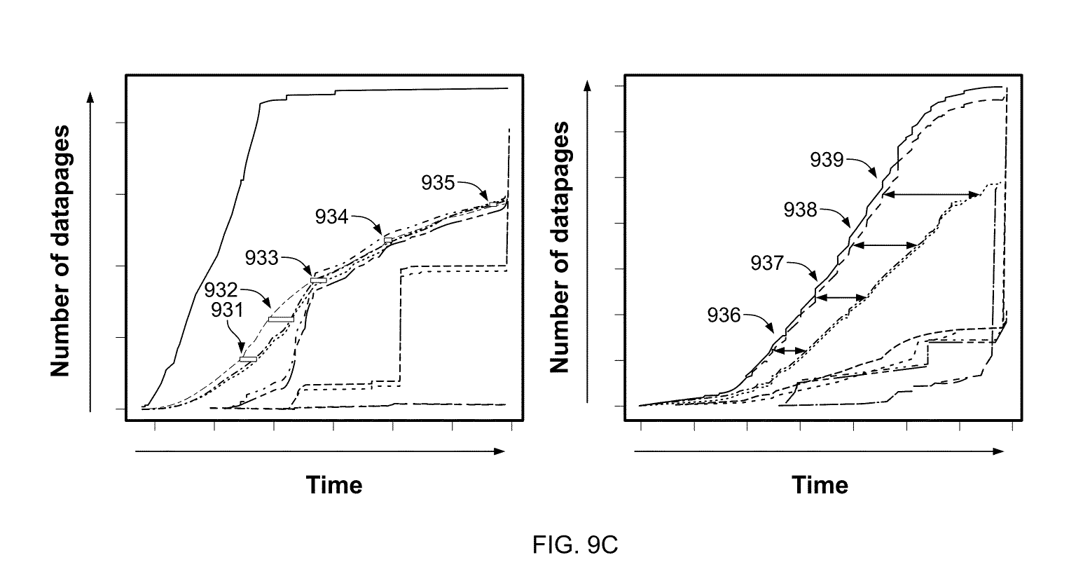

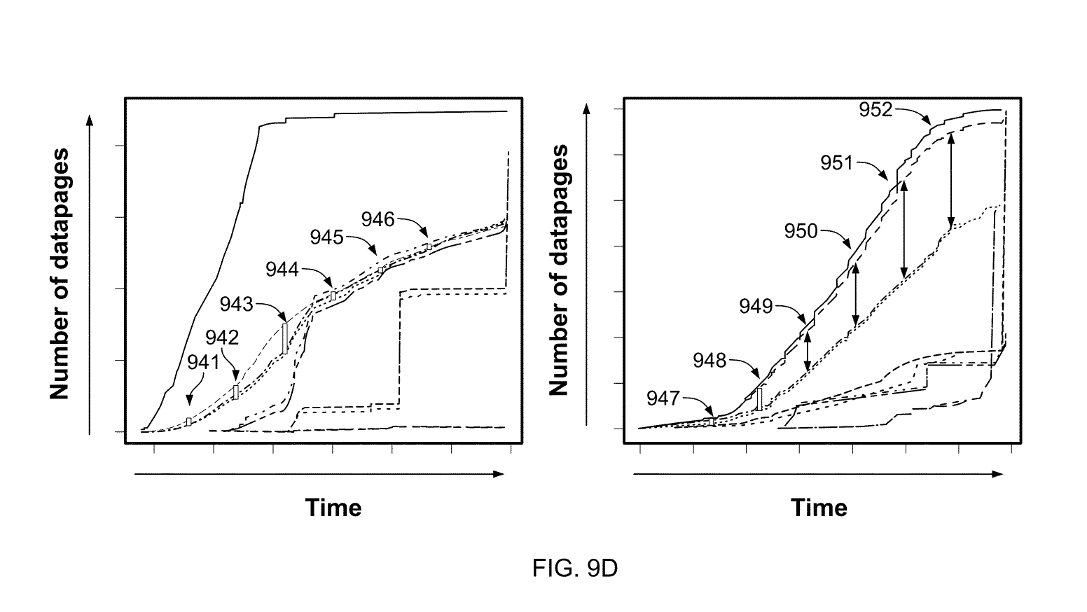

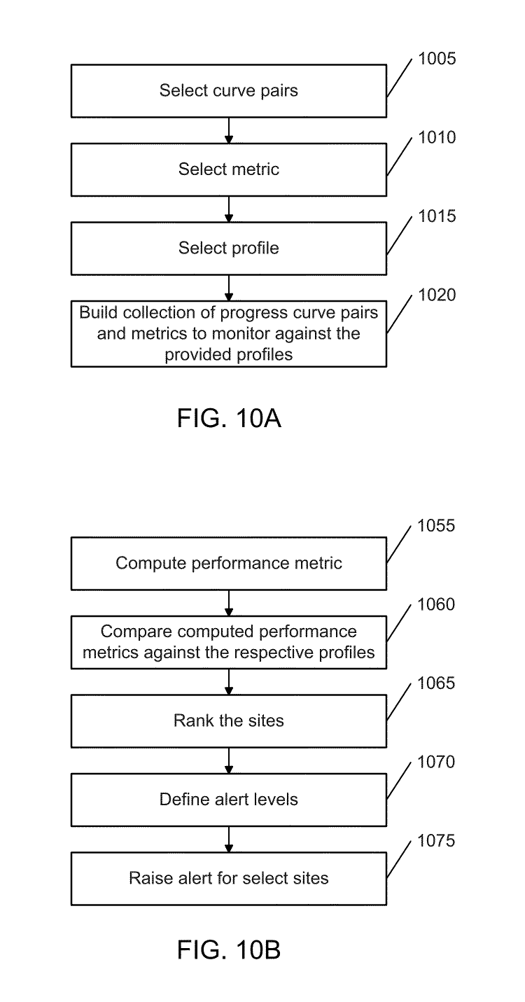

Metrics module 360 may present data and curves on a user's computer, which may be the same computer as that used to visualize the curves or may be a different computer. Metrics module 360 may allow a user to choose which metrics to calculate and/or display based on the curves stored in progress curve database 327. This module may provide recommendations and/or status of the clinical trial, and may provide alerts if a trial is not proceeding according to plan. Some examples of metrics are shown in FIGS. 8 and 9A-9D, and are discussed further in the flowcharts in FIGS. 10A and 10B.

The operation of some of the modules in FIG. 3A will now be discussed in more detail. FIG. 3B is a block diagram of part of system 300 describing how progress curves may be calculated and generated, according to an embodiment of the present invention. FIG. 3B includes progress curve generator 370 having several inputs, 362-368, and outputting progress curves 375. Datapoints (in datapages or forms) typically contain data, but may also have attributes or properties such as present state, visibility, and actions required. “Present state” may include the current state of the datapoint or datapage, such as those shown in FIG. 1, e.g., verified, locked, not frozen, etc. “Visibility” includes whether the data are hidden or visible to the user. “Actions required” may include checks on the data, for example, an automatic range check that notices that the weight of an adult is 18 lbs. and sets an alert to verify whether this weight is correct.

Input 362 may include a list of datapoints with their respective attributes or properties as just described. Input 364 may include a sequence of historical events or audits for the datapoints, which may include the historical audits stored in statuses/audits database 323. Input 366 may include a list of datapages accompanied by a list of datapoints associated with each datapage. Input 368 may include the datapage state for which the progress curve is to be generated, which may include the current statuses stored in statuses/audits database 323.

The blocks shown in FIGS. 3A and 3B are examples of modules that may comprise system 300 and do not limit the blocks or modules that may be part of or connected to or associated with these modules. For example, networks 310, 340 are shown, but information may not need to be transmitted over a network either to or from block 320. Instead, block 320 may be a standalone computer system or a system operating on a standalone computer and the inputs and outputs may be connected within the computer or via wires or wireless transmission. Visualization module 350 and metrics module 360 may be presented on the same or different computer and may even be presented on the same computer that includes block 320. In addition, the modules within block 320 may not reside on a single computer, but may be part of a distributed network. The calculations for the visualization and metrics may be performed by progress tracking service 330 or by visualization module 350 and metrics module 360 themselves. The blocks in FIGS. 3A and 3B may be implemented in software or hardware or a combination of the two, and may include processors, memory, and software instructions executed by the processors.

FIG. 4 is a flowchart of a method for determining the state of a datapage, according to an embodiment of the present invention. This flowchart includes operations of historical statuses reconstruction module 324 and generates aggregated tracking data 325. In operation 405, datapoints of interest may be selected as well as their respective sequence of audit events. At the datapoint level, this sequence can be shown using the arrows in FIG. 1, an example of which may be: created-entered-verified-unverified-verified-frozen-locked-unlocked-locked. In operation 410, the list of events (audits) may be built using the following values for a variable called “DP_Action”:
a. assign “1” to events that attain the evaluated state, e.g., if the evaluated state is “verified,” then assign “1” when the datapoint or datapage is verified;
b. assign “−1” to events that undo the evaluated state (in addition to the explicit undo event, other events may implicitly have an undo effect—for example, changing the value of a verified field will revert any prior verification); and
c. assign “0” to all other events (e.g., query events).

In operation 415, pairs of values may be built for each consecutive sequence of events for a datapoint. To do this, call the first audit event “Initial_DP_Action.” Then, for each subsequent event E_{T}, generate or build a pair of values {DP_Action (E_{T}), DP_Action (E_{T-1})}. In operation 420, DP_Action (E_{T}) values from operation 415 where the DP_Action values differ (i.e., DP_Action (E_{T}) # DP_Action (E_{T-1})) are taken and then summed to generate a variable called “SUM_DP_Action.”

Table 1 shows an example of a sequence of events for a single datapoint, with an indication of the events that include a transition to or from the evaluated state (which is verification in this example):

TABLE 1

| | | | Verified/ | |
|---|---|---|---|---|
| Time T | Event Name | DP_Action | Unverified? | Change? |
| 1 | Entered | −1 | UV | |
| 2 | Verify | 1 | V | Y |
| 3 | Query Open | −1 | UV | Y |
| 4 | Query Answer | 0 | UV | |
| 5 | Entered | −1 | UV | |
| 6 | Query Close | 0 | UV | |
| 7 | Verify | 1 | V | Y |
| 8 | Entered | −1 | UV | Y |
| 9 | Query Open | −1 | UV | |
| 10 | Query Cancel | 0 | UV | |
| 11 | Query Open | −1 | UV | |
| 12 | Verify | 1 | V | Y |
| 13 | Entered | −1 | UV | Y |
| 14 | Query Answer | 0 | UV | |
| 15 | Entered | −1 | UV | |
| 16 | Query Open | −1 | UV | |
| 17 | Query Close | 0 | UV | |
| 18 | Verify | 1 | V | Y |
| 19 | Query Answer | 0 | V | |
| 20 | Entered | −1 | UV | Y |
| 21 | Query Close | 0 | UV | |
| 22 | Verify | 1 | V | Y |

SUM_DP_Action sums the DP_Action values from the time points in which direction the change occurred relative to the first DP_Action (or “Initial_DP_Action”) (i.e., the entries with a “Y” in the Change column, indicating a transition from 1 to −1 or from −1 to 1). Combining SUM_DP_Action with the initial action (Initial_DP_Action) determines the current state and processes all time points in which there was a state change (i.e., all time points with “Y” entries in the Change column).

In operation 425, a state is assigned to each datapoint (i.e., a state is determined for each datapoint) based upon Table 2:

TABLE 2

| SUM_DP_Action | Initial_DP_Action | Assigned State |
|---|---|---|
| 1 | 1 | 1 |
| 0 | 1 | 0 |
| 0 | −1 | 1 |
| −1 | −1 | 0 |

For the data in Table 1, SUM_DP_Action=1, Initial_DP_Action=1, so the Assigned State=1. The sequence of events as shown in Table 1 pertains to one datapoint, so the process is applied to each datapoint separately to determine its state and the course of past events. Then, in operation 430, the datapage state can be set to 1 if all datapoints in the datapage are in state 1, otherwise the datapage state remains 0.

By considering events only up to a time point T, the state at time T may effectively be computed for the datapoints and thus the datapages. This can be done at any time T or later. This method allows for arbitrary time points T, so this method allows state activities to be collapsed to the last state activity, e.g., daily, weekly, monthly, etc. This is one of the aspects of aggregating the tracking data depicted in FIG. 3A.

Using realistic clinical trial data, generating progress curves that track state changes on short time scales may introduce unnecessary detail that may not be usable or actionable. States may frequently fluctuate in the range of a few hours to a day, but these fluctuations typically have no effect on the overall progress of data management. With this in mind, embodiments of the invention include a method to generate progress curves that may replace the “true” curve with two proxy progress curves called “First State” and “Last State.” First State captures the earliest time point t_{F} at which all datapoints in a given datapage existed in the given state (verified, locked, etc.) at or before time t_{F}, and Last State captures the latest time point t_{L} at which the datapage state changes to a given state. Examples of such progress curves are “First Verified,” “Last Verified,” “First Locked,” “Last Frozen,” etc.

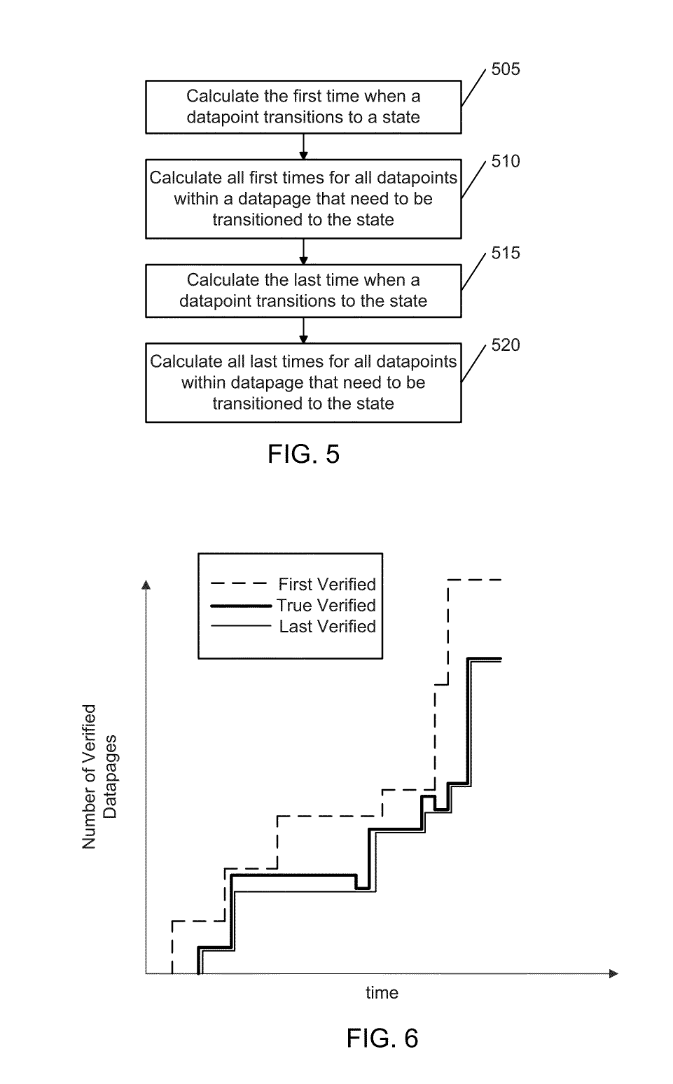

The First State and Last State progress curves can be computed as described in the flowchart in FIG. 5. The First State progress curve can be computed as described in operations 505 and 510. In operation 505, for each datapoint that is to be transitioned (or actioned) to the state (entered, verified, frozen, etc.) the first time FT when a datapoint i transitions to that state is calculated as FTᵢ (so FTᵢ=t_{F}). If datapoint i never transitioned to the state, then FTᵢ=N/A. In operation 510, if all datapoints within the datapage that are to be transitioned to the state have transitioned to that state, the maximum of all times FT for all those datapoints is calculated: if all FTᵢ≠ N/A, then FT(datapage)=max(FTᵢ).

Similarly, the Last State progress curve can be computed as described in operations 515 and 520. In operation 515, for each datapoint that is to be transitioned to the state the last time LT when the datapoint i transitioned to that state is calculated as LTᵢ (so LTᵢ=t_{L}). If datapoint i never transitioned to the state, then LTᵢ=N/A. In operation 520, if all datapoints within the datapage that are to be transitioned to the state have transitioned to that state, the maximum of all times LT for all those datapoints is calculated: if all LTᵢ≠N/A, then LT(datapage)=max(LTᵢ).

FIG. 6 shows examples of the First State, Last State, and True progress curves for the Verified state. As stated above, the First and Last curves do not necessarily track all of the fluctuations that the True curve has, so they may be calculated more quickly. The time FT may provide information as to when a datapage could have been transitioned to the specified State, so calculating both the LT and FT information provides additional information as to the time lag between the theoretical minimum time and the actual time. The curves in FIG. 6 may be visualized using visualization module 350 shown in FIG. 3A.

FIGS. 7A and 7B show examples of groups of study progress curves, according to embodiments of the present invention, for two different trials. The curves shown include Page Created/Instance Date, Page Entered, First Verified, Current Verified, First Signed, Current Signed, First Frozen, Current Frozen, First Locked, and Current Locked. The curves in FIGS. 7A and 7B may be visualized using visualization module 350 shown in FIG. 3A.

In addition to capturing trends in data acquisition and quality assurance, progress curves as described in this invention can be also used to measure trends that inform or alert users on patterns or events of interest.

Individual progress curves can be characterized individually or with respect to averaged progress curves from multiple trials (e.g., industry standard curves based on similar trials in size, therapeutic area, phase, etc.), but also comparatively to other progress curves. Two ways in which progress curves can be compared are (1) “completion” between the curves, i.e., the degree to which one curve has approached another at various time points; and (2) “delay,” i.e., the time point at which one progress curve will reach the same level as another. When measured systematically over time, these metrics may also be indicative of completion and/or delay trends. In addition to computing these metrics for various curve pairs, they may also be computed for subsets of data in a trial. For example, computing such metrics for each clinical site or a group of sites may be used to monitor the progress of a clinical trial in which resources may be optimized or refocused, or, at the very least, the metrics may provide a comparative baseline for the trial or the sites.

Reference is now made to FIG. 8, which shows several examples of how progress curves can be compared over time. FIG. 8 includes the same three curves in FIG. 6 plus a “Created” curve to the left. Comparison of these curves is as follows:
Arrow 801 shows completion between two curves—here, completion between created and true verified curves.
Arrow 802 shows completion between first state and last state curves—here, completion between first verified and last verified curves.
Arrow 803 shows completion between first state and true curves—here, completion between first verified and true verified curves.
Arrow 811 shows delay between first state and true curves—here, delay between first verified and true verified curves.
Arrow 812 shows delay between first state and last state curves—here, delay between first verified and last verified curves.
Arrow 813 shows delay between two curves—here, delay between created and true verified curves.

One way to compute delay or completion trends is to sample the progress curves at regular time intervals or regular number of datapage intervals. For example, for completion trends, the progress curves may be sampled weekly and form a vector of values that captures the difference between the curves. Similarly, for delay, the progress curves may be sampled at different points in accumulation of datapages (e.g., every 100 datapages) or at regular time intervals on one of the progress curves (e.g., weekly on datapage creation).

FIGS. 9A-9D show several examples of the results of such periodic sampling methods. The left graph in each figure is from one trial—essentially the same graph as that shown in FIG. 7A; the right graph in each figure is from a second trial, part of which is shown in FIG. 7B. Alternatively, graphs from different sites in the same trial or in different trials could be compared. FIG. 9A shows the delay between datapages created and entered, as indicated by 911-919. The plot on the left shows a large delay, which may indicate a problem in that trial. FIG. 9B shows completion between datapages created and entered, as indicated by 920-929. Again, the plot on the left shows a large completion difference, which may indicate a problem in that trial. FIG. 9C shows delay between datapages entered and last verified, as indicated by 931-939. In this case, the delay on the left is less than the delay on the right, which indicates that the same trial can have large delays and small delays at the same time, depending on the curves being examined. FIG. 9D shows completion between datapages entered and last verified, as indicated by 941-952. In this case, the completion on the left is less than the completion on the right, which indicates that the same trial can have large completions and small completions at the same time, depending on the curves being examined.

The progress of a clinical trial may be monitored using the progress curves and the metrics (completion and delay) discussed above. FIG. 10A is a flowchart showing how the system as a whole operates, according to an embodiment of the invention. In operation 1005, a user of a system may select the progress curve pairs to be monitored, e.g., created and verified, entered and frozen. In operation 1010, the user may select the metric to be used, e.g., completion or delay.

In operation 1015, the user may select a profile, which is a sequence of target values over time. Examples of profiles may be historical, manual, and a combination of the two. A historical profile uses data taken from completed and ongoing trials and takes into account trial type, number of subjects, therapeutic area, keywords, trial phase, etc. A manual profile may be created by the user, who can provide criteria against which performance is monitored. One example is setting a target value at each time point in the trial, e.g., 75% datapages verified after two months into the trial, 85% verified after four months into the trial, and then 95% through the end of the trial. A combination profile may also be created by the user, but is based on a historical profile whose parameters are then adjusted by the user according to the needs of the trial. Table 3 shows one example of a profile based on historical data:

TABLE 3

| | Participation time length | | | | |
|---|---|---|---|---|---|
| | and target (weeks) | | | | |
| | 0-2 | 2-6 | 6-12 | 12-36 | 36+ |
| Allowed delay between data | 7 | 10 | 15 | 15 | 20 |
| entered and verified (days) | | | | | |

After selecting the curve pairs, the metric, and a profile, in operation 1020, the system may build or generate a collection of progress curve pairs and metrics to monitor against the provided profiles.

FIG. 10B is a flowchart showing tasks the system may perform, periodically or at relevant points in data acquisition, for each pair for a given site or for a trial as a whole, according to an embodiment of the invention. In operation 1055, the system may compute a performance metric. This may be calculated at the present time or as a function of historical metric values, e.g., the average metric value for the past month or the median metric value from the beginning of the trial. In operation 1060, the system may compare the computed performance metrics against the respective profiles and indicate distance from the selected profile. In operation 1065, in the case of site performance metrics, the system may rank the sites based on the distance from the selected profile. In operation 1070, the system may define alert levels to highlight sites with a large deviation from the profile target, and in operation 1075, the system may raise an alert for sites that exceed the alert levels.

Besides the operations shown in FIGS. 1, 4, 5, 10A, and 10B, other operations or series of operations are contemplated to monitor clinical trial progress. In FIG. 1, the states mentioned are not intended to be limiting—as shown in FIGS. 7A and 7B, there may also be states called “Instance Date” and “Signed.” Moreover, the actual orders of the operations in the flow diagrams are not intended to be limiting, and the operations may be performed in any practical order. For example, although the arrows in the forward direction in FIG. 1 show progression from states one through five, in some embodiments states may be skipped, even in the forward direction.

One benefit of the present invention is that the progress of a trial may be monitored without needing to monitor individual patients and it may be done remotely. Poor performance may be indicated by large delays or completion differences at one site compared to another, or by not meeting expected profile targets. By being able to identify progress trends on a site basis, a trial basis, or other parametrical basis, site monitors may be able to identify poor-performing sites or slow sites and concentrate monitoring on those sites, with the possible goal of finishing the trial more quickly and therefore saving money for the sponsor or contract research organization (CRO). Such monitoring may include calling the site and asking why there are deviations or sending people to the site to verify the data or the collection processes.

The present invention differs from other systems that monitor progress. For example, those systems may have significant time lags and may not provide a detailed view of the data collection and management. Those systems may also look at only the current status of data and ignore historical changes in the data collection process.

Aspects of the present invention may be embodied in the form of a system, a computer program product, or a method. Similarly, aspects of the present invention may be embodied as hardware, software or a combination of both. Aspects of the present invention may be embodied as a computer program product saved on one or more computer-readable media in the form of computer-readable program code embodied thereon.

For example, the computer-readable medium may be a computer-readable signal medium or a computer-readable storage medium. A computer-readable storage medium may be, for example, an electronic, optical, magnetic, electromagnetic, infrared, or semiconductor system, apparatus, or device, or any combination thereof.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Computer program code in embodiments of the present invention may be written in any suitable programming language. The program code may execute on a single computer, or on a plurality of computers. The computer may include a processing unit in communication with a computer-usable medium, wherein the computer-usable medium contains a set of instructions, and wherein the processing unit is designed to carry out the set of instructions.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method for calculating a progress curve for a clinical trial state, comprising:
assigning values to events for a datapoint in the clinical trial;
generating pairs of values for each consecutive sequence of the events;
summing up the values of pairs of events corresponding to a state change; and
determining a state for the datapoint based on the sum of the values.

2. The method of claim 1, further comprising determining a state for a plurality of datapoints in a datapage.

3. The method of claim 2, further comprising determining a state for the datapage based on the states of the plurality of datapoints in the datapage.

4. The method of claim 1, further comprising calculating a first state curve based on the time when the first datapoint reaches said state.

5. The method of claim 1, further comprising calculating a current state curve based on the time when the last datapoint reaches said state.

6. A system for monitoring progress of a clinical trial, comprising:
a data collector including a processor for collecting data from at least one clinical trial database and for producing current statuses of the trial and historical audits;
an historical statuses reconstructer including a processor for converting the current statuses and historical audits to generate aggregated tracking data;
a progress curve generator including a processor for converting the aggregated tracking data to calculate a first progress curve for a first state of the clinical trial over a time period and a second progress curve for a second state of the clinical trial over the same time period; and
a progress tracking service for transmitting first and second progress curves to a user,
wherein the progress curve for a state comprises an amount of datapages within that state.

7. (canceled)

8. The system of claim 6, wherein a datapage is considered within a state when all of the datapoints in the datapage are within that state.

9. The system of claim 6, wherein the progress tracking service compares the delay between points of the first progress curve and the second progress curve.

10. The system of claim 6, wherein the progress tracking service compares the completion between the first progress curve and the second progress curve.

11. A method for monitoring progress of a clinical trial, comprising:
calculating a first progress curve for a first state of the clinical trial over a time period;
calculating a second progress curve for a second state of the clinical trial over the same time period; and
comparing the delay between points of the first progress curve and the second progress curve to assess the quality of the clinical trial,
wherein:
the progress curve for a state comprises an amount of datapages within that state; and
a datapage is considered within a state when all of the datapoints in the datapage are within that state.

12. The method of claim 11, wherein the first and second states are selected from data entered, verified, and locked.

13. The method of claim 11, further comprising comparing the completion between the first progress curve and the second progress curve.

14. The method of claim 11, wherein the first progress curve is calculated by:
assigning values to events for a datapoint in the clinical trial;
generating pairs of values for each consecutive sequence of the events;
summing up the values of pairs of events corresponding to a state change;
determining a state for the datapoint based on the sum of the values; and
determining a state for a datapage comprising a plurality of datapoints based on the states of the plurality of datapoints.

15. A method for monitoring progress of a clinical trial, comprising:
calculating a progress curve for a state of the clinical trial over a time period;
accessing a performance profile for clinical trial progress; and
comparing the progress curve to benchmarks in the performance profile.

16. The method of claim 15, wherein the performance profile comprises historical information.

17. The method of claim 15, wherein the performance profile comprises a combination of historical information and information from the clinical trial.

18. The method of claim 15, wherein the progress curve is calculated by:
assigning values to events for a datapoint in the clinical trial;
generating pairs of values for each consecutive sequence of the events;
summing up the values of pairs of events corresponding to a state change;
determining a state for the datapoint based on the sum of the values; and
determining a state for a datapage comprising a plurality of datapoints based on the states of the plurality of datapoints.
